(19) United States
(12) Patent Application Publication
(10) Pub. No.: US 2009/0021531 A1
(43) Pub. Date: Jan. 22, 2009

(54) Window or door showing remote scenery in real-life motion

(76) Inventor: Vlad Vasilescu, Redondo Beach, CA (US)

Correspondence Address: LOUIS VENTRE, JR, 2483 OAKTON HILLS DRIVE, OAKTON, VA, 22124-1530, US

(21) Appl. No.: 11/780,582

(22) Filed: Jul. 20, 2007

(51) Int. Cl. G09G 5/00

(52) U.S. Cl. 345/633

(57) ABSTRACT

A device and method to show scenery in a window (100) or door (200) from a remote location in realistic motion for decoration and relaxation. An embodiment of the device includes a camera (320); a processor (340); a window (100) or door (200); a display screen (110) embedded within the window (100) or door (200); and, a digital video player (130) embedded within the window (100) or door (200). A method of using the device includes steps for operating the camera; extracting the stored digital video from storage; customizing the digital video in the processor; recording the customized digital video in the removable storage media; transporting the removable storage media to the digital video player; extracting the digital video from the removable storage media with the digital video player; and playing the extracted digital video using the digital video player (130) such that it is shown on the display screen (110).

### FIELD OF INVENTION

In the field of decorative display devices and methods for using such devices, a panel, or group of panels, in combination with a door or window displays remote scenery in real-life motion.

### BACKGROUND OF THE INVENTION

The display of static images in false windows is a known decoration technique. However, improvements in computers and television display devices have made it possible to incorporate a display device within a window (100) or door (200) to give a real-life experience in viewing scenery recorded in a remote location. The invention takes the art of decoration to a realm of realism that has not previously been attained and is a new and innovative improvement to the prior art in decoration and relaxation.

### DESCRIPTION OF PRIOR ART

The use of a static drawing, poster or painting placed behind a window to simulate a view of scenery is known. For example, U.S. Pat. No. 6,918,199 on Jul. 19, 2005 is for a decorative device having the appearance of a window or door and displaying an external scenery. The decorative device can be mounted to a wall and is intended to look just like a window, a door or a portal, including the traditional trim and angled surfaces. The window or door is in combination with a picture or poster containing a scene (which can be placed within or behind the window trim). The window or door has the appearance of being opened while being arranged generally parallel to the front surface of the trim portion.

The present invention is different from the '199 patent disclosure in that it incorporates a video display screen within the door or window, it enables transmission and display of a video of scenery, that is, a live or pre-recorded view of scenery with all the inherent motion of the natural or urban environment. It realistically shows the scenery as if through the window or door, as that scenery were actually through the window or door.

Accordingly, the present invention will serve to improve the state of the art by providing a significantly more realistic means of decoration and relaxation in showing scenery in realistic motion to a viewer seemingly looking through a window or door at a remote location.

### BRIEF SUMMARY OF THE INVENTION

A device and method shows scenery in a door or window from a remote location in realistic motion for decoration and relaxation. An embodiment includes a camera having capability for digital video recording of scenery and storage of the recording; a processor connected to the camera that can extract digital video from storage, customize it, and store it on removable storage media; a window or door; a display screen embedded within the window or door that can receive digital video from a digital video player and that has a flat screen less than about 5 inches in depth; and, a digital video player embedded within the window or door that accesses the digital video from the storage media and sends it to the display screen. A method of using the device includes steps for operating the camera to record and store digital video of scenery; extracting the stored digital video from storage; customizing the digital video in the processor to satisfy the requirements of the display screen; recording the customized digital video in the removable storage media; transporting the removable storage media to the digital video player embedded within the window or door; extracting the digital video from the removable storage media with the digital video player; and playing the extracted digital video using the digital video player such that it is shown on the display screen.

### BRIEF DESCRIPTION OF THE DRAWINGS

Referring now to the drawings in which like reference numbers represent corresponding parts throughout:

FIG. 1 is a front view of a window with components of alternative embodiments of the invention.

FIG. 2 is a front view of a door with components of alternative embodiments of the invention.

FIG. 3 is a flow diagram of alternative embodiments of the invention.

### DETAILED DESCRIPTION

In the following description, reference is made to the accompanying drawings, which form a part hereof and which illustrate preferred embodiments of the present invention. The drawings and preferred embodiments of the invention are presented with the understanding that the present invention is susceptible of embodiments in many different forms and, therefore, other embodiments may be utilized and structural and operational changes may be made without departing from the scope of the present invention.

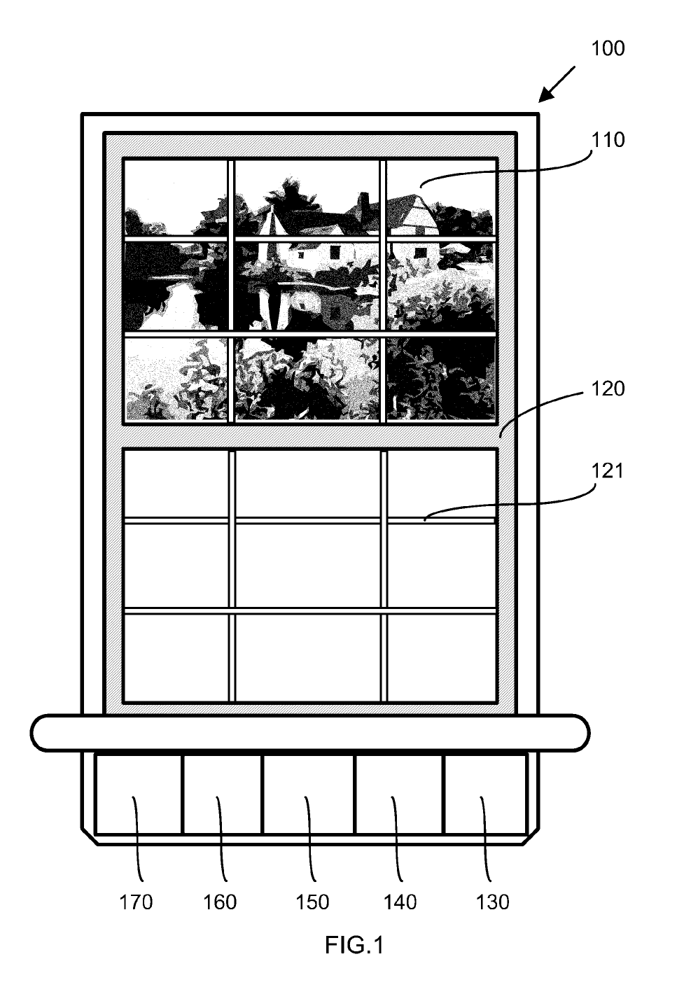

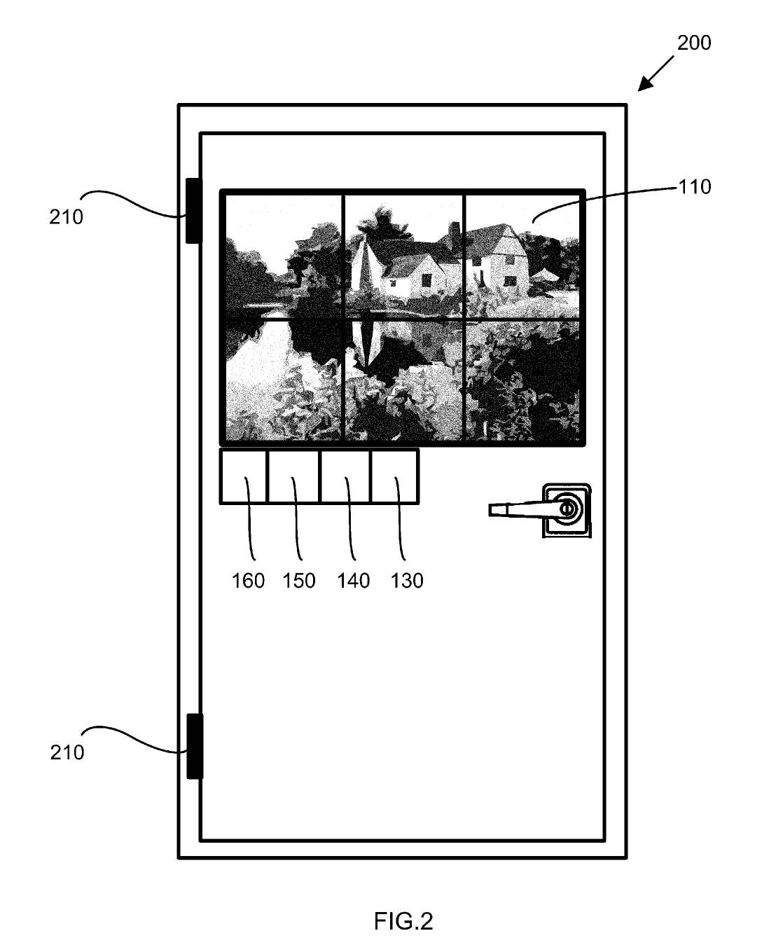

FIG. 1 shows a window (100) with components of embodiments of the invention. Similarly, FIG. 2 shows a door (200) with components of embodiments of the invention. Thus, the invention is a combination including an access portal. An access portal as used herein is a door usable by a person for entry or exit, or a window commonly, but not exclusively, used to view the outside world.

FIG. 1 shows a display screen (110) within a window frame (120) having mullions (121). In various embodiments, five additional components are embedded in the window frame (120) at the bottom and are, from right to left: a digital video player (130); a wireless receiver (140); an aroma emitter (150); a processor (160); and an electrical power inlet (170), which enables operability of the components in the door or window. These five components and the display screen (110) are collectively referred to as the window or door display system (360).

A preferred embodiment includes a display screen (110), a digital video player (130), and an electrical power inlet (170) embedded within the window (100) or door (200).

Optionally, the aroma emitter (150) and processor (160) are also embedded in the window (100) or door (200) to add functionality. The aroma emitter (150) provides a fresh air or other scent to enhance the enjoyment and relaxation potential of the invention

The digital video player (130) has means to extract a digital video from the removable storage media and to send said digital video to the display screen (110). For example, when the removable storage media is a digital video disk, the digital video player (130) is a mini-DVD player with output to the display screen (110).

The processor (160) is a digital processor and comprises processor accessible memory and software to provide menu driven control features that permit a viewer to play a video of scenery repetitively and to choose from a collection of videos of scenery stored within the processor accessible memory. The processor (160) permits customization of a digital video to customize the display of the video to fit the display design in the window (100) or door (200). This option facilitates display screen shapes within an access portal that are outside of normal television display screen proportions, and also permits multiple display screens. For the latter, the processor (160) would digitally customize the video so that scenery is displayed across all the display screens as a single video.

For alternative embodiments, the processor is operably connected to the digital video player (130) to provide menu driven control features that permit a viewer to play a video of scenery repetitively and to choose from a collection of videos of scenery stored within the DVD player or other digital video memory media.

For alternative embodiments, the processor, which is operably linked to the wireless receiver (140), can customize a wirelessly received digital video to fit the design of the display screen, to implement command signals from a remote control or other transmitting devices, and to send a customized digital video to the display screen. The processor holds the requisite software, which are commonly available, to implement these functions.

The same components would be located in a door around the frame, except that as shown in FIG. 2, hinges (210) would provide the means to route electrical power to the components in the door.

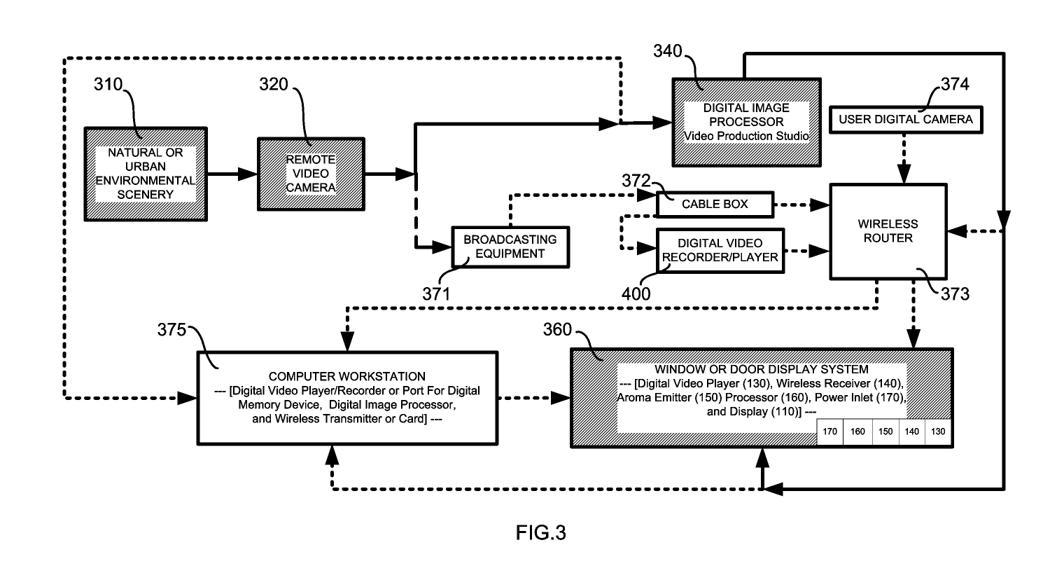

FIG. 3 illustrates several embodiments of the invention in applications for decoration and relaxation in a window (100) or door (200) located, for example inside an apartment, house, or office to give to persons therein a realistic view of natural or urban environmental scenery (310) from a remote location. A preferred embodiment is illustrated with boxes having diagonal-line hatching. The boxes are connected by solid arrows indicating either an operable linkage or a component in the operable chain of components in an embodiment. Broken or dashed lines indicate optional components in alternative embodiments.

For various embodiments, a realistic view is remote scenery in motion, for example, motion captured in the field of view of a remote video camera (320) in its remote location. The camera (320) is the means for digital video recording of scenery and also the means for storing said recording. A means for storing said recording is commonly found in digital video cameras and provides a capability to record digital video on digital video storage media that is either removable from the camera or is accessible to permit downloading the recorded digital video from said storage media.

For most embodiments, the camera (320) is set in a fixed position with no camera movement, no fade-in/out, no zoom in/out, and no panning.

The camera (320) records and stores raw digital video on any digital memory media, such as a DVD, hard drive, or flash drive. The digital video is preferably of the natural or urban environmental scenery (310) at the remote location that is physically remote from the window (100) or door (200).

An alternative embodiment uses a camera at the remote location that may or may not have a recording function, but has a means for wireless digital video transmission. This means for wireless digital video transmission is the hardware needed to produce a live transmission of a video signal to broadcasting equipment (371), such as the typical equipment used by a satellite or other cable television or Internet company which is capable of receiving the digital video from the camera, and transmitting the digital video to a cable box.

For a preferred embodiment noted above, a digital image processor (340), is operably connected to the camera to extract digital video from storage. The digital image processor (340) is at a location different than the window (100) or door (200).

The processor (340) connection to the camera would typically be via directly wired connection, a wireless connection; or simply hand carrying a camera's (320) detachable storage media, such as a DVD disk or flash drive, to the processor (340).

The processor (340) has a means to customize digital video and a means for removable digital video storage. A processor of this type is well known and can be considered the equivalent of a digital video production or customization studio.

The means to customize digital video is software enabling editing and reformatting digital videos to meet the requirements for displaying the digital video on a variety of display screens.

The means for removable digital video storage is any removable digital storage media, such as a digital video disk, a flash drive, or a removable hard drive.

The processor (340) enables transforming the raw digital video, such that it is customized to fit the window (100) or door (200) display system (360). For example, where multiple display screens are installed in a window (100) or door (200), the processor (340) has a capability to digitally alter the video so that scenery is displayed across all the display screens as a single video. The processor (340) may also have a means for wireless digital video transmission so that a video transmission could be sent directly to the wireless receiver (140) embedded in the window (100) or door (200), to the wireless router (373), or to a computer work station (375). The wireless router (373) may be connected to the processor (340) by any operable linkage, such as a wireless or wired connection, which is a commonly available option in wireless routers. Typical wired connections are an Ethernet network, or a wired network using transmission via electrical power wires or phone land lines.

In alternative embodiments, processor (340) functions are also or instead implemented using the computer work station (375) with installed software, or multiscreen processor card, that processes the scenery video to fit the display type. Ideally, the computer work station (375) has a wireless receiver to receive a digital video wirelessly transmitted from the wireless router (373) or the processor (340), software to customize the digital video as necessary for display on a particular display screen, and a wireless transmitter capable of transmitting a digital video to the wireless receiver (140) embedded within the window (100) or door (200). The computer work station (375) also has the typical processor accessible memory and operational software and may be operated by a viewer to customize application of the video to the viewer's window (100) or door (200) structural and electronic display configuration. The computer work station (375) preferably has the capabilities to record a customized digital video on removable storage media such as on a DVD or flash drive, and access and play removable storage media.

For a preferred embodiment, a DVD disk, flash drive, removable hard drive, or any other means for removable digital video storage, is used to store the customized digital video produced by the processor (340). This means for digital video storage is then physically taken to the window (100) or door (200) and inserted into, or connected to, such as through a USB port, the digital player (130), which is capable of extracting a digital video from the removable storage media and sending said digital video to the display screen (110).

For the preferred embodiment noted in the preceeding paragraph, a display screen (110) is embedded within the window (100) or door (200) and has a means to receive digital video, which is the hardware enabling the display screen (110) to receive a digital video transmission and show the digital video and being further defined as having a flat screen less than about 5 inches in depth. Such display screens are widely available and recent developments have made organic LED display screens about 3 millimeters thick. Thus, the display screen (110) is typically a flat panel display screen, for example any of a liquid crystal display, flat panel plasma screen, organic LED display, and a flat panel high-definition television screen.

Alternative embodiments employ more than one display screen (110) in an access portal. For example in FIG. 1, a display screen (110) could be a single display screen behind the mullions (121), or it could be 6 separate display screens, each one fitting between the mullions (121). For embodiments with multiple display screens, the invention typically includes a processor (160) having a capability to digitally transform the video so that scenery is displayed across all the display screens as a single video. The common display screen (110) capabilities and physical characteristics comprise a display screen (110) that is embedded within the window (100) or door (200), can receive digital video from the digital video player (130), and has a flat screen that is less than about 5 inches in depth. Examples of display screens having these capabilities and physical characteristics are a flat panel liquid crystal display, plasma screen, organic LED display, and high-definition television screen.

Alternative embodiments use a wireless receiver (140) embedded within the window (100) or door (200). The wireless receiver (140) has a means for receiving a wireless digital video transmission and a means for sending the digital video. The means for receiving a digital video transmission is a commonly available component typically having a receiving antenna and hardware for receiving a digital video signal. A means for sending said digital video is also a commonly available component that will send a hard wired or wireless digital video signal, for example to the processor (160) or directly to the display screen (110). Thus, it is capable of receiving a digital video wireless transmission from the computer work station (375), receiving command signals from a remote control or other transmitting devices, and sending that video transmission to the display screen (110).

In an alternative embodiment, a digital video from a user's digital video camera (374) is operably connected to the wireless router (373). The user's digital video camera comprises a means for digital video recording of scenery and means for storing of said recording. The means for storing is operably connected to a wireless router for example by hard wire or by wireless connection. The wireless router (373) has a means to wirelessly transmit a digital video to a wireless receiver, for example the wireless receiver (140) in the window (100) or door (200) or to the wireless receiver in the computer work station (375). A wireless receiver, which is a means to receive a digital video wirelessly transmitted from the wireless router, is a commonly available product.

The computer work station (375) has a means to customize the digital video as necessary for display on a particular display screen. This is commonly available software that enables any necessary customization of the digital video to meet the requirements of the display screen (110). After such customization, the digital video is sent to the wireless receiver (140) embedded in the window (100) or door (200).

The wireless receiver (140) has a means for receiving a wireless digital video transmission and a means for sending the digital video, as previously described. The display screen (110) has a means to display a digital video received from the wireless receiver. This means comprises the standard equipment found in digital video display screens.

An alternative embodiment of the invention includes a touch-sensitive detector, such as a touch-sensitive display screen, operably connected to activate or turn off the display screen (110). In other embodiments, the display screen may be turned off, for example, at the access portal, the computer workstation (375) or the wireless router (373), employing a switch activated by remote control or by manual engagement.

In an alternative embodiment, the camera (320) transmits live, real time video using broadcasting equipment (371), that is the typical equipment used by a satellite or other cable television or Internet company. This embodiment typically sets one or more video cameras in remote places and transmits the scenes to subscribers. The broadcast equipment (371) is capable of receiving the digital video signal from the camera (320) and transmitting the digital video to a cable box (372), which then sends that signal to a wireless router (373) or to a digital video recorder and player (400). The digital video recorder and player (400) is connected to the cable box (372) and to the wireless router (373) and may play any digitally recorded image at the complete discretion of the viewer.

The wireless router (373) is operably connected to the cable box (372) and digital video recorder and player (400). The computer work station (375) is wirelessly connected to the wireless router (373) and the wireless receiver (140) in the window (100) or door (200). Since the computer work station (375) can store the digital video on video storage media that is readable by the digital video player (130), the digital video could be placed on storage media and the storage media physically transported to the digital video player (130) in the window (100) or door (200).

In alternative embodiments, the video of scenery is pre-recorded video of scenery from a remote location. The scenery is depicted in natural, full motion and is not a static image.

A method of using the preferred embodiment of the invention includes steps performed in no particular order, except that the method must result in the display of an image of full motion scenery on the display screen (110). The method is described with reference to FIG. 3.

This embodiment includes a first step of operating the camera (320) to record and store digital video of scenery, preferably natural or urban environmental scenery (310). The full motion concept captures the movement of leaves by wind currents, animals or other natural or urban environment subjects passing within the field of view of the camera (320). In this embodiment, the camera (320) is set in position with no movement of the camera (320) or field of view.

A second step is extracting the stored digital video from storage. This may be by a wired connection or simply transferring the camera's digital video storage media, such as a DVD or flash drive, to the processor (340).

A third step is customizing the digital video in the processor (340) to satisfy the requirements of the display screen (110) within a window (100) or door (200).

A fourth step is recording the customized digital video in the removable storage media, which is operably connected to the processor (340).

A fifth step is transporting the removable storage media to the digital video player (130) embedded within the window (100) or door (200).

The remaining steps are preferably performed by components embedded with the window (100) or door (200), shown as within the window or door display system (360) in FIG. 3.

A sixth step is extracting the digital video from the removable storage media with the digital video player (130). The removable digital storage media, such as a DVD or flash drive, would be inserted or connected to the digital video player and operated in the usual fashion.

A seventh step is playing the extracted digital video using the digital video player (130) such that it is shown on the display screen, which would typically be hard wired to the digital video player (130), but may be any operable connection.

An alternative embodiment of the method includes steps of transmitting the digital video from the broadcasting equipment (371) so that it is received at the cable box (372); sending the digital video from the cable box so that it is received by the wireless router (373); transmitting the digital video from the wireless router (373) to the computer work station (375); customizing the digital image in the computer work station (375) as necessary for display on the display screen (110); transmitting the customized digital video so that it is received by the wireless receiver (140) embedded within the window (100) or door (200); and, sending the digital video to the display screen (110) to display the digital video.

The invention includes an access portal that is a faux window or door, placed so as to give the appearance of being a real window or door. The display may be a flat screen television. In this case, the window is a French-style faux frame holding a flat panel television. If closed, it simulates viewing a prerecorded remote scenery, if open it actually allows access to viewing TV broadcast programming.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

What is claimed is:

1. A device to show scenery from a remote location in realistic motion for decoration and relaxation comprising:
(a) a camera comprising a means for digital video recording of scenery and means for storing of said recording;
(b) a processor operably connected to the camera to extract digital video from storage, said processor having means to customize digital video and means for removable digital video storage;
(c) an access portal selected from a group consisting of a window and door;
(d) a display screen embedded within the access portal, said display screen comprising a means to receive digital video from a digital video player, and wherein said display screen having a flat screen and being less than about 5 inches in depth; and,
(e) a digital video player embedded within the access portal, said digital video player comprising a means to extract a digital video from the removable storage media and to send said digital video to the display screen.

2. The device of claim 1 wherein the processor operably connected to the camera further comprises a means for wireless digital video transmission.

3. The device of claim 2 further comprising a wireless receiver embedded within the access portal, said wireless receiver comprising a means for receiving said wireless digital video transmission and a means for sending said digital video.

4. The device of claim 1 wherein the display screen is selected from a group consisting of a flat panel liquid crystal display, plasma screen, organic LED display, and high-definition television screen.

5. The device of claim 1 further comprising at least one additional display screen embedded within the access portal and wherein the processor has a capability to digitally customize the video so that scenery is displayed across all the display screens as a single video.

6. The device of claim 1 further comprising a touch-sensitive detector operably connected to activate or turn off the display screen.

7. The device of claim 1 further comprising a switch to power off the display screen.

8. The device of claim 1 further comprising an aroma-emitter embedded in the access portal.

9. The device of claim 1 further comprising a power inlet embedded within the access portal.

10. A method of using the device of claim 1 comprising the steps of:
(a) operating the camera to record and store digital video of scenery;
(b) extracting the stored digital video from storage;
(c) customizing the digital video in the processor to satisfy requirements of the display screen;
(d) recording the customized digital video in the removable storage media;
(e) transporting the removable storage media to the digital video player embedded within the access portal;
(f) extracting the digital video from the removable storage media with the digital video player; and,
(g) playing the extracted digital video using the digital video player such that it is shown on the display screen.

11. A device to show scenery in realistic motion for decoration and relaxation comprising:
(a) a camera comprising a means for digital video recording of scenery and means for storing of said recording, said means for storing being operably connected to a wireless router;
(b) a wireless router comprising a means to wirelessly transmit a digital video to a wireless receiver;
(c) an access portal selected from a group consisting of a door and window;
(d) a wireless receiver embedded within the access portal comprising means for receiving a wireless digital video transmission and a means for sending the digital video; and,
(e) a display screen embedded within the access portal comprising a means to display a digital video received from the wireless receiver wherein said display screen is any flat screen less than about 5 inches in depth.

12. The device of claim 11 further comprising a computer work station wherein the computer work station comprises a means to receive a digital video wirelessly transmitted from the wireless router; a means to customize the digital video as necessary for display on a particular display screen; and a wireless transmitter capable of transmitting a digital video to the wireless receiver embedded within the access portal.

13. A device to show scenery from a remote location in realistic motion for decoration and relaxation comprising:
(a) a camera capable of transmitting a digital video of scenery;
(b) broadcasting equipment capable of receiving the digital video from the camera, and transmitting the digital video to a cable box;
(c) a cable box capable of receiving the digital video from the broadcasting equipment;
(d) a wireless router operably connected to the cable box;
(e) an access portal selected from a group consisting of a window and door;
(f) a computer work station wherein the computer work station comprises a means to receive a digital video wirelessly transmitted from the wireless router; a means to customize the digital video as necessary for display on a particular display screen; and a wireless transmitter capable of transmitting a digital video to the wireless receiver embedded within the access portal;
(g) a display screen embedded within the access portal comprising a means to show a digital video received from the wireless receiver wherein said display screen is any flat screen less than about 5 inches in depth; and,
(h) a wireless receiver embedded within the access portal comprising a means to receive a digital video transmitted from the computer work station; and, a means to send the digital video to a display screen.

14. The device of claim 13 further comprising a digital video recorder and player connected to the cable box wherein the digital video recorder is connected to the wireless router.

15. The device of claim 13 wherein the computer work station further comprises a digital video recorder/player; a port for accessing removable storage media; and, a multiscreen processor card.

16. A method of using the device of claim 13 comprising the steps of:
(a) transmitting a digital video of scenery from the digital video camera so that it is received by the broadcasting equipment;
(b) transmitting the digital video from the broadcasting equipment so that it is received at the cable box;
(c) sending the digital video from the cable box so that it is received by the wireless router;
(d) transmitting the digital video from the wireless router to the computer work station;
(e) customizing the digital image in the computer work station as necessary for display on the display screen;
(f) transmitting the customized digital video so that it is received by the wireless receiver embedded within the access portal; and,
(g) sending the digital video to the display screen to display the digital video.
